(19) United States
(12) Patent Application Publication
(10) Pub. No.: US 2011/0091700 A1
(43) Pub. Date: Apr. 21, 2011

(54) MICROELECTRONIC PROCESSING COMPONENT HAVING A CORROSION-RESISTANT LAYER, MICROELECTRONIC WORKPIECE PROCESSING APPARATUS INCORPORATING SAME, AND METHOD OF FORMING AN ARTICLE HAVING THE CORROSION-RESISTANT LAYER

(75) Inventor: Matthew A. Simpson, Sudbury, MA (US)

(73) Assignee: SAINT-GOBAIN CERAMICS & PLASTICS, INC., Worcester, MA (US)

(21) Appl. No.: 12/907,426

(22) Filed: Oct. 19, 2010

Related U.S. Application Data
(60) Provisional application No. 61/253,245, filed on Oct. 20, 2009.

(51) Int. Cl. B32B 7/02; B32B 3/26; B32B 5/14; C23C 4/00; B05C 13/00; C23F 1/08

(52) U.S. Cl. 428/215; 428/312.8; 428/310.5; 427/446; 118/500; 156/345.51

(57) ABSTRACT

A microelectronic processing component can include a substrate and a corrosion-resistant layer. The substrate can include a metal-containing material, and the corrosion-resistant layer can be adjacent to the surface region. The corrosion-resistant layer can include a first portion and a second portion each including a rare earth compound, wherein the first portion is disposed between the substrate and the second portion, and the first portion has a first porosity, and the second portion has a second porosity that is greater than the first porosity. The component can be component within a processing apparatus used to process microelectronic workpieces. In a particular embodiment, the component can be exposed to the processing conditions as seen by the microelectronic workpiece when fabrication a microelectronic device from the microelectronic workpiece. Methods can be used to achieve the difference in porosity, and such methods can be for articles other than microelectronic processing components.

### CROSS-REFERENCE TO RELATED APPLICATION

This application claims priority under 35 U.S.C. §119(e) to U.S. Patent Application No. 61/253,245 entitled “Microelectronic Processing Component Having Corrosion-Resistant Layer, Microelectronic Workpiece Processing Apparatus Incorporating Same, and Method of Forming an Article Having the Corrosion-Resistant Layer,” by Simpson, filed Oct. 20, 2009, which is assigned to the current assignee hereof and incorporated herein by reference in its entirety.

### BACKGROUND

1. Field of the Invention

The present invention is generally directed to microelectronic processing components, microelectronic workpiece processing apparatuses incorporating articles, microelectronic workpiece processing, and methods of forming articles.

2. Description of the Related Art

In many industries, it is generally desirable to provide components having certain requisite thermal, mechanical, electrical, and chemical properties. Particularly in the area of microelectronic processing, certain properties can be of marked importance in the successful processing of microelectronic workpieces, such as semiconductor wafers, to form devices with high yield rates. In connection with microelectronic processing, various processes take place to form microelectronic components, such as logic devices and memory devices contained within individual die of a processed semiconductor wafer. Such processing operations include implant and diffusion, photolithography, film deposition, planarization, test, and assembly (packaging). In connection with the foregoing general processing operations in the microelectronics industry, processing operations such as patterning typically use selected gaseous reactants that are employed to remove material from the microelectronic workpiece. Such processes may be used to remove selected portions of a deposited layer (such as in photolithography/selective etching), the entirety of a deposited layer, or to generally clean a wafer or another workpiece. A certain species of these processes include what is known as etching.

Etching processes typically employ fairly highly reactive gas species, many times relying upon halogen species gases. An ongoing problem in the microelectronic workpiece processing industry is implementation of processing tools that have adequate chemical resistance to such species, particularly at elevated temperatures. In this regard, it has been found that components used in certain processing tools, such as etch chambers, tend to corrode causing increases in particle counts during processing. As is well understood in the art, it is typically desirable to minimize generation of particles in such controlled environments, as particles negatively impact microelectronic yield.

Efforts attempting to improve corrosion resistance has been reported. U.S. Pat. No. 7,329,467 discloses an article that includes a substrate and a corrosion-resistant layer on the substrate. The substrate generally consists essentially of alumina, and the corrosion-resistant layer is provided so as to directly contact the substrate without the provision of an intervening layer between the substrate and the corrosion-resistant layer. The corrosion-resistant layer generally consists essentially of a rare earth oxide and has an adhesion strength not less than about 15 MPa.

U.S. Pat. No. 6,783,863 discloses an internal member for a plasma treating vessel having resistance to chemical corrosion and plasma erosion under an environment containing a halogen gas. The member is formed by covering a surface of a substrate with a multilayer composite layer consisting of a metal layer formed as an undercoat, Al₂O₃ film formed on the undercoat, and a Y₂O₃ sprayed coated having a porosity of 0.2 to 10% on the Al₂O₃ film.

Accordingly, in view of the foregoing, it is generally desirable to provide improved components having corrosion resistance, which may find particular use in the microelectronics industry, as well as improved microelectronic workpiece processing apparatuses, methods for processing microelectronic workpieces, and methods of processing ceramic components.

### BRIEF DESCRIPTION OF THE DRAWINGS

Embodiments are illustrated by way of example and are not limited in the accompanying figures.

FIG. 1 illustrates a microelectronic processing apparatus according to an embodiment of the present invention.

FIG. 2 illustrates a microelectronic processing apparatus according to another embodiment of the present invention.

FIG. 3 illustrates scribe lanes of semiconductor die of a semiconductor wafer.

FIG. 4 illustrates a flat panel display.

FIG. 5 illustrates a substrate and a corrosion-resistance layer according to a particular embodiment of the present invention.

FIG. 6 illustrates a substrate and a corrosion-resistance layer according to another particular embodiment of the present invention.

FIG. 7 illustrates a substrate, an intervening layer, and a corrosion-resistance layer according to a further particular embodiment of the present invention.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

Before addressing details of embodiments described below, some terms are defined or clarified. The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive- or and not to an exclusive- or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise. For example, when a single item is described herein, more than one item may be used in place of a single item. Similarly, where more than one item is described herein, a single item may be substituted for that more than one item.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the ceramic materials arts and microelectronic processing and related equipment arts.

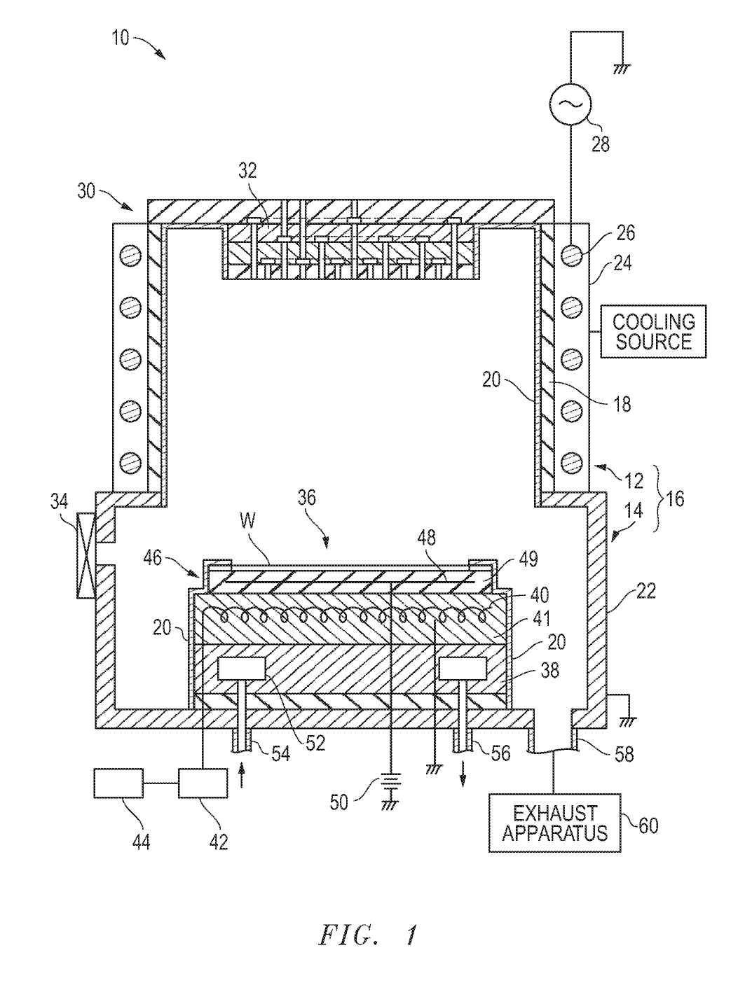

According to an aspect of the present invention, a processing apparatus for processing microelectronic workpieces is provided. Microelectronic workpieces can include semiconductor wafers, quartz or glass panels from which displays, such as flat panel displays, are formed, or other similar base material from which microelectronic devices are formed. The apparatus may be particularly configured to receive various gaseous species for reaction with a microelectronic workpiece provided within a chamber of the apparatus, and the apparatus may be used for cleaning, etching, deposition processing, among others. Turning to FIG. 1, an embodiment is illustrated in which an apparatus 10 includes a chamber 16 having an upper chamber 12 and a lower chamber 14. The chamber defines therein an internal volume in which the processing steps take place. Generally speaking, the chamber 16 is defined by chamber walls. As used herein, the terms “chamber walls” or “walls” are used generally, to denote the structure defining the internal volume of the processing apparatus, and may include generally vertical walls or sidewalls, and generally horizontal walls such as a lid or floor. The upper chamber 12 includes a sidewall 18, which, together with showerhead 30 forming a lid portion of the upper chamber 12, defines an internal processing volume of the upper chamber 12. According to a particular feature of this embodiment, the sidewall 18 includes a layer 20 deposited thereon. In a particular embodiment, the layer 20 is a corrosion-resistant layer, and is described in more detail hereinbelow.

Depending upon the particular processing operations to be carried out, a coil 26 is provided so as to generally surround the sidewall 18. The coil 26 is coupled to high-frequency power source 28 and generates of a high-frequency electromagnetic field. Further, optionally, a cooling mechanism 24 is connected to a cooling source to aid in temperature control within the upper chamber 12.

According to another particular feature of the embodiment, at least one gas inlet 32 is provided so as to be in gaseous communication between the chamber 16 and an outside gas source (not illustrated), which may include a reactant gas for microelectronic processing. In the particular embodiment illustrated in FIG. 1, a plurality of gas inlets are provided through a multilayered structure referred to herein as showerhead 30.

Turning to the lower chamber 14, a workpiece support 36 is generally provided within lower chamber wall 22. As illustrated, the workpiece support 36 is provided so as to support and position workpiece W, which may be brought into the apparatus 10 through opening gate 34. The workpiece support 36 generally has a chucking feature, and in this case, includes electrostatic chuck 46. As is generally understood in the art, an electrostatic chuck provides an electrostatic attraction force by putting an embedded electrode at a desired potential. In this case, embedded electrode 48 is biased via DC power source 50 to provide the desired electrostatic chucking force on workpiece W, particularly when the workpiece W includes a semiconductor wafer. Further, a workpiece support 36 also generally includes a heating element 40 embedded in heating layer 41, the heating element being connected to a power source 42 and controller 44 for maintaining the workpiece W at a desired temperature, which is dependent upon the particular processing operation taking place. Further, the support base 38 includes coolant chamber 52, which may have an annular cross-section (as viewed in the plane perpendicular to the plane of FIG. 1), being in fluid communication with coolant intake 54 and coolant exhaust 56, for flow of coolant fluid through the coolant chamber 52.

According to a particular feature illustrated in FIG. 1, the layer 20 may extend so as to cover not only sidewall 18 of upper chamber 12, but also the workpiece support 36, and the lid portion of the upper chamber 12 formed by showerhead 30. Although not illustrated in the FIG. 1, an interior barrier wall may be provided in the space between the lower chamber wall 22 and the workpiece support 36. This interior barrier wall, also known as a liner, may be desirably formed of a robust metal or ceramic material, generally including a base material such as an aluminum or ceramic base material that may be used for sidewall 18, and further, coated with corrosion-resistant layer 20.

In operation, typically the microelectronic workpiece is loaded through gate 34 and placed onto workpiece support 36 and positioned thereon by the electrostatic chucking force provided by electrostatic chuck 46. In operation, oftentimes an electromagnetic field is generated by the coil 26, and at least one reactant gas is flowed into the chamber through at least one of the gas inlets 32. Unreacted, produce, carrier, or other gases can be removed from the chamber 16 by an exhaust apparatus 60 via an exhaust port 58.

As to the particulars of the processing operation, as noted above, the operation may be an etching, cleaning or deposition process, any one of which may use desirable reactant species, some of which have generally corrosive properties. In this regard, exemplary etching gases are listed below in Table 1.

TABLE 1

| Material Being Etched | Chemistry I | | | Chemistry II |
|---|---|---|---|---|
| PolySi | Cl₂ or BCl₃/CCl₄ | | | SiCl₄/Cl₂ |
| | /CF₄ | | sidewall | BCI₃/Cl₂ |
| | /CHCl₃ | {close oversize brace} | passivating gases | HBr/Cl₂/O₂ |
| | /CHF₃ | | | HBr/O₂ |
| | | | | Br₂/SF₆ |
| | | | | SF₆ |
| | | | | CF₄ |

| | | |
|---|---|---|
| Al | Cl₂ | SiCl₄/Cl₂ |
| | BCl₃ + sidewall passivating gases | BCI₃/Cl₂ |
| | SiCl₄ | HBr/Cl₂ |
| Al—Si (1%)—Cu (0.5%) | Same as Al | BCl₃/Cl₂ + N₂ |
| AI—Cu (2%) | BCl₃/Cl₂/CHF₃ | BCl₃/Cl₂ + N₂ + AI |
| W | SF₆/Cl₂/CCl₄ | SF₆ only |
| | | NF₃/Cl₂ |
| TiW | SF₆/Cl₂/O₂ | SF₆ only |
| WSi₂, TiSi₂, CoSi₂ | CCl₂F₂ | CCl₂F₂/NF₃ CF₄/Cl₂ |
| Single crystal Si | Cl₂ or BCl₃ + sidewall passivating gases | CF₃Br |
| | | HBr/NF₃ |
| SiO₂ (BPSG) | CCl₂F₂ | CCl₂F₂ |
| | CF₄ | CHF₃/CF₄ |
| | C₂F₆ | CHF₃/O₂ |
| | C₃F₈ | CH₃/CHF₂ |
| Si₃N₄ | CCl₂F₂ | CF₄/O₂ |
| | CHF₃ | CF₄/H₂ |
| | | CHF₃ |
| | | CH₃CHF₂ |
| GaAs | CCl₂F₂ | SiCl₄/SF₆ |
| | | /NF₃ |
| | | /CF₄ |
| InP | None | CH₄/H₂ |
| | | HI |

As generally shown in Table 1, various gaseous chemistries may be used for etching of different materials that are commonly employed in microelectronic processing, many of which have corrosive properties, including the halogen-containing gases such as the chlorine- or fluorine-based gases. The column entitled Chemistry I generally denotes conventionally used chemistries, while Chemistry II represents newer generation chemistries more commonly found in modern microelectronic processing. The introduction of relatively newer materials in the microelectronic fabrication process such as low-K dielectrics, high-K dielectrics, refractory metals and their nitrides, noble metals, such as copper, may also require use of new chemistries, additional chemistries, or a combination thereof.

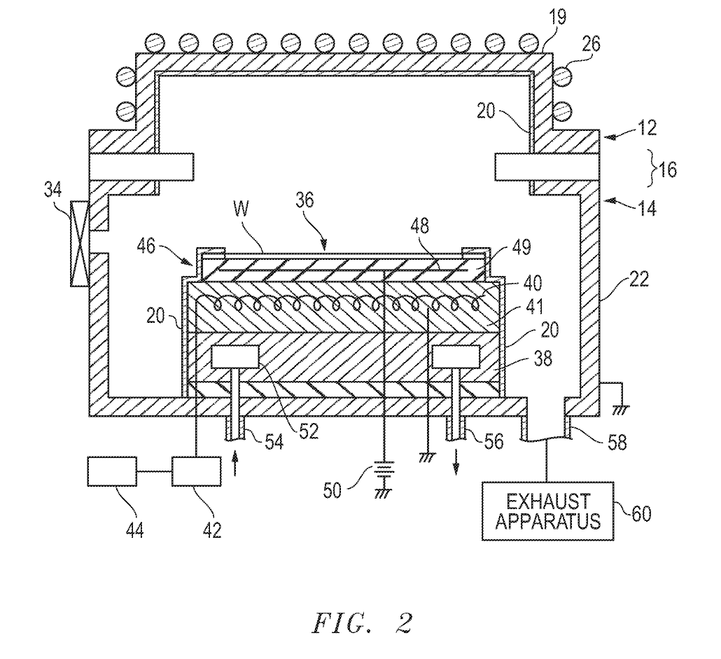

FIG. 2 illustrates another embodiment, generally similar to FIG. 1, but having a different contour for the upper chamber 12. In this regard, the components similar to those illustrated in FIG. 1 are labeled with the same reference numerals, and a detailed discussion is not provided. However, in the apparatus illustrated in FIG. 2, the upper chamber 12 is generally defined by lid 19, extending generally horizontally, with short vertical sidewalls. This lid 19, forming a wall of the chamber, is coated with corrosion-resistant layer 20. In addition, gases are generally introduced through the gas inlets (not illustrated).

Following processing of the microelectronic workpiece in the processing apparatus described herein, the workpiece may be subjected to additional processing operations, which may include any one of the general process operations described herein, such as deposition, planarization, further photolithographic and etching processing operations. When the microelectronic workpiece includes a semiconductor wafer, upon completion of processing, the semiconductor wafer is generally diced into individual semiconductor die. This operation is illustrated in FIG. 3, illustrating workpiece W, which is diced into individual die 102 by sawing, using a laser, high pressure water, or another suitable cutting tool, along scribe lanes 100. Following the dicing operation, the individual die are generally packaged, such as in a flip-chip package, plastic encapsulated package, a pin-grid or a ball-grid array package, or any one of the various packages known in the art, including multi-chip modules (MCMs). The packaged semiconductor die, forming semiconductor components, may be then incorporated into microelectronic devices. Generally speaking, the semiconductor devices contain at least one of logic circuitry and memory circuitry, respectively forming logic devices and memory devices.

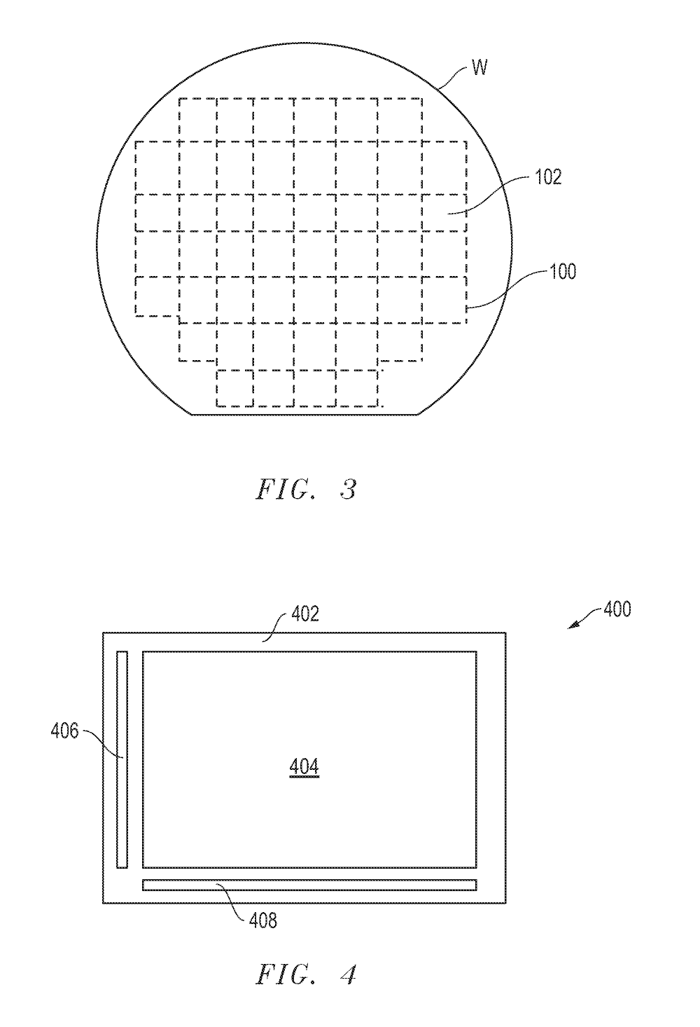

The concepts as described herein can be further extended to another type of microelectronic workpiece. FIG. 4 illustrates a flat panel 400 that includes a quartz or glass plate 402. Microelectronic components can be formed over the plate 402 to form the display matrix 404 and circuits 406 and 408. The display matrix 404 can include light-emitting diodes, display elements for a liquid crystal or electrochromic display, other suitable components, or any combination thereof. The display matrix 404 can be configured to operate as a passive matrix or an active matrix. Circuits 406 may include a row decoder, a row array strobe, a pixel driver, other suitable circuitry, or any combination thereof, and circuits 408 may include a column decoder, a column array strobe, a pixel driver, other suitable circuitry, or any combination thereof. Part or all of the display elements in the display matrix 404, and circuits 406 and 408 can be formed or otherwise fabricated over the plate 402 using a microelectronic processing apparatus as described herein.

As noted above, according to a particular feature of an embodiment of the present invention, at least some portion of the chamber of the processing apparatus is defined by a member or other component coated with a corrosion-resistant layer. In the case of FIGS. 1 and 2, the components within the chamber are represented by sidewall 18 and lid 19, respectively, each coated with corrosion-resistant layer 20. FIGS. 5 to 7 include illustrations of particular embodiments in which components include a substrate and a corrosion-resistant layer adjacent to the substrate. After reading this specification, skilled artisans will appreciate that in other embodiments, other components can be formed in which a corrosion-resistant layer is adjacent to a substrate.

Referring to FIG. 5, a component 500 includes a substrate 502 and a corrosion-resistant layer 520 adjacent to the substrate 502. In this particular embodiment, the corrosion-resistant layer 520 directly contacts the substrate 502, and in another particular embodiment, the component 500 is free of an intervening layer that would otherwise be disposed between the substrate 502 and the corrosion-resistant layer 520. In one embodiment, the substrate 502 includes a single material or, in another embodiment, the substrate includes a surface region that includes the metal-containing material adjacent to a base layer. The substrate 502 can include any one of various metal-containing materials, including alumina, silicon carbide, aluminum nitride, or stainless steel. According to a particular embodiment, the metal-containing material consists essentially of alumina, aluminum nitride, or stainless steel. In another particular embodiment, the metal-containing material is an aluminum-containing material. In a more particular embodiment, the metal-containing material consists essentially of α-alumina (corundum). In still other embodiment, the substrate 502 has a base layer primarily including aluminum or an aluminum alloy having a surface region that includes anodized aluminum.

The corrosion-resistant layer 520 includes an appropriate corrosion-resistant material. Typically, the corrosion-resistant material includes a rare earth compound, such as a rare earth oxide, a rare earth fluoride, or any combination thereof. In one embodiment, the corrosion-resistant layer 520 consists essentially of a rare earth compound. As used herein, description of “consisting essentially of” in connection with the rare earth compound of the corrosion-resistant layer generally indicates that at least 80 wt. % of the layer is formed of the rare earth compound, more typically, at least about 90 wt. %, and in certain embodiments, greater than 95 wt. %. Further, as used herein, the term “rare earth” includes not only the lanthanide series elements, but also yttrium and scandium as well. In one embodiment, the rare earth oxide can have a molecular formula of Re₂O₃, wherein Re is a rare earth element or a combination of rare earth elements. In another embodiment, the rare earth oxide can include a rare earth aluminate or a rare earth silicate. According to a particular embodiment, a particular rare earth is yttrium (Y), thereby forming a corrosion-resistant layer consisting essentially of Y₂O₃. In another embodiment, the rare earth oxide can include Ce or La. In particular embodiments, the rare earth oxide includes CeO₂, a yttria aluminate, a yttrium silicate, a lanthanum aluminate, a lanthanum silicate, or the like. In a further embodiment, the rare earth fluoride can have a molecular formula of ReF₃ or ReF₄, wherein Re is a rare earth element or a combination of rare earth elements. In a particular embodiment, the rare earth fluoride includes YF₃, CeF₃, CeF₄, or the like.

In other embodiments, particular transition metals in the corrosion-resistant layer 520 may be avoided to reduce the likelihood of contaminating microelectronic workpieces that are processed using the component 500. In an embodiment, the corrosion-resistant layer 520 may not have more than 5 wt. % of Cr, Mn, Fe, Co, Ni, Cu, or any combination thereof. In another embodiment, the corrosion-resistant layer 520 may not have more than 1 wt. % of Cr, Mn, Fe, Co, Ni, Cu, or any combination thereof, and in another embodiment, the corrosion-resistant layer 520 may not have more than 0.1 wt. % of Cr, Mn, Fe, Co, Ni, Cu, or any combination thereof. In a further embodiment, the total transition metal content in the corrosion-resistant layer 520 may be less than 5 wt. %, in still a further embodiment, the total transition metal content in the corrosion-resistant layer 520 may be less than 1 wt. %, and in yet a further embodiment, the total transition metal content in the corrosion-resistant layer 520 may be less than 0.1 wt. %.

As illustrated in the embodiment of FIG. 5, the corrosion-resistant layer includes portions 522 and 524, wherein the portion 522 is disposed between the substrate 502 and the portion 524. In one embodiment, the portion 522 has a lower porosity, and hence a higher density, than the portion 524. In a particular embodiment, the portion 522 may be better at corrosion resistance than the portion 524. The portion 524 can still provide sufficient resistance to erosion, such as physical abrasion, scratches, or other physical phenomenon, and costs less to form on a per-unit-thickness basis than the portion 522.

More specifically, the portion 522 can have a porosity sufficient to provide corrosion-resistance needed or desired. If the porosity is too low, the risk of the portion 522 spalling may be unacceptably high. In a particular embodiment, the portion 522 has a porosity of at least approximately 0.5%. The porosity within the portion 522 may approach the level that can be used within the portion 524. In a particular embodiment, the portion 522 has a porosity no greater than approximately 5%. In another particular embodiment, the portion 522 has a porosity no greater than approximately 3.5% or even 3%. In an embodiment, the area used for determining porosity can be at least approximately 1 cm², wherein the area is along a plane that is substantially perpendicular to the thickness of the corrosion-resistant layer 520 or a portion thereof. In another embodiment, a larger area, such as at least 10 cm² is used for determining porosity. In a particular embodiment, a sample can be prepared by cross sectioning a workpiece with the substrate and corrosion resistant layer and polishing the sample. The sample can be placed into a scanning electron microscope or other similar tool to obtain a micrograph image of the sample. An operator can define an analysis area and instruct a computer regarding a border between the solid material of the corrosion-resistant layer and a pore. For example, the solid material may be Y₂O₃ and appear white on the micrograph image, and a pore may appear black. The operator may select a shade of gray corresponding to the border between the Y₂O₃ material and a pore. Based on the operator input, a computer program can be run to analyze and calculate the porosity. Although operators may differ on the selection of the shade of gray, results between different operators typically vary by no more than 20% (e.g., for the same sample, one operator may get 2.0% porosity, and another operator may get 2.5% porosity).

The portion 522 can have a thickness such that it will not be eroded during the initial formation of the portion 524. In a particular embodiment, the portion 522 has a thickness of at least approximately 15 microns. In another particular embodiment, the portion 522 has a thickness of at least approximately 50 microns. Although no theoretical upper limit to the thickness of the portion 522 is known, after a particular thickness, the portion 522 may serve no further benefit that could not be achieved by the portion 524. In a particular embodiment, the portion 522 has a thickness no greater than approximately 450 microns. In another particular embodiment, the portion 522 has a thickness no greater than approximately 200 microns.

The portion 524 has a higher porosity and can be formed at a relatively lower cost than the portion 522. If the porosity of the portion 524 is too low, the risk of spalling of the corrosion-resistant layer 520 may be too high. In another particular embodiment, the portion 524 has a porosity of least approximately 5%. In a further particular embodiment, the portion 524 has a porosity of at least approximately 7%. When porosity of the portion 524 is too high, particulate generation may be an issue. In a particular embodiment, the portion 524 has a porosity no greater than approximately 25%. In another particular embodiment, the portion 524 has a porosity no greater than approximately 15%. In a further particular embodiment, the portion 524 has a porosity of no greater than approximately 10%. When comparing the porosities of the portions 522 and 524, the porosity of the portion 524 can be at least approximately 1.1 times greater than the porosity of the portion 522. When put into the form of an equation, in accordance to a particular embodiment:

Porosity_{portion 524}≧1.1×Porosity_{portion 522}

In another particular embodiment, the porosity of the portion 524 can be at least approximately 1.2 times greater than the porosity of the portion 522, in another embodiment the porosity of the portion 524 can be at least approximately 1.5 times greater than the porosity of the portion 522. In a more particular embodiment, the porosity of the portion 524 can be at least approximately 2.0 times greater than the porosity of the portion 522.

The portion 524 can have a thickness such that the total thickness of the corrosion-resistant layer 520, as needed or desired, is achieved. In a particular embodiment, the portion 524 has a thickness of at least approximately 25 microns. In another particular embodiment, the portion 524 has a thickness of at least approximately 70 microns. Although no theoretical upper limit to the thickness of the portion 524 is known, after a particular thickness, the portion 524 may serve no further benefit. Particular applications of the processing apparatus may include sputter etching, ion milling, or another operation that may cause relatively more erosion at an exposed surface of the portion 524, as compared to reactive ion etching and plasma etching. In a particular embodiment, the portion 524 has a thickness no greater than approximately 800 microns. In another particular embodiment, the portion 524 has a thickness no greater than approximately 300 microns.

In the embodiment illustrated in FIG. 5, the porosity within the corrosion resistant layer 520 changes as a function of the distance from the substrate 502. In a particular embodiment, the function is a discontinuous function, and thus, portions 522 and 524 can be discrete films. In another embodiment, the function is a continuous function and the porosity can increase linearly, exponentially, or asymptotically from the substrate 502. In a particular embodiment, 10% of the total thickness of the corrosion-resistant layer 520 closest to the substrate 502 has an averaged porosity as described with respect to the portion 522. In another particular embodiment, 10% of the total thickness of the corrosion-resistant layer 520 farthest from the substrate 502 has an averaged porosity as described with respect to the portion 524. As used herein, the term “averaged,” when referring to a value, is intended to mean an average, a geometric mean, or a median. In still another embodiment, end portions of the corrosion-resistant layer (closest and farthest from the substrate) each have a relatively uniform porosity and a transition portion may be disposed between the two end portions in which the porosity increases as a continuous function as the distance from the substrate 502.

FIG. 6 illustrates another embodiment of a component 600 that includes a substrate 602 and a corrosion-resistant layer 620. The substrate 602 can include any of the materials as previously described with respect to the substrate 502. In this embodiment, the corrosion resistant layer 620 includes alternating portions of relatively more dense and relatively more porous films, illustrated as portions 622, 624, 626, and 628 in FIG. 6. In a particular embodiment, each of portions 622 and 626 are less porous than each of portions 624 and 628. The portion 624 may help to accommodate stress and allow the combined thickness of the portions 622 and 626 to be thicker before spalling would occur. The portions 622 and 626 can have the same porosity or different porosities, and the same thickness or different thicknesses. The portions 624 and 628 can have the same porosity or different porosities, and the same thickness or different thicknesses. In another embodiment, a larger number of alternating portions may be used.

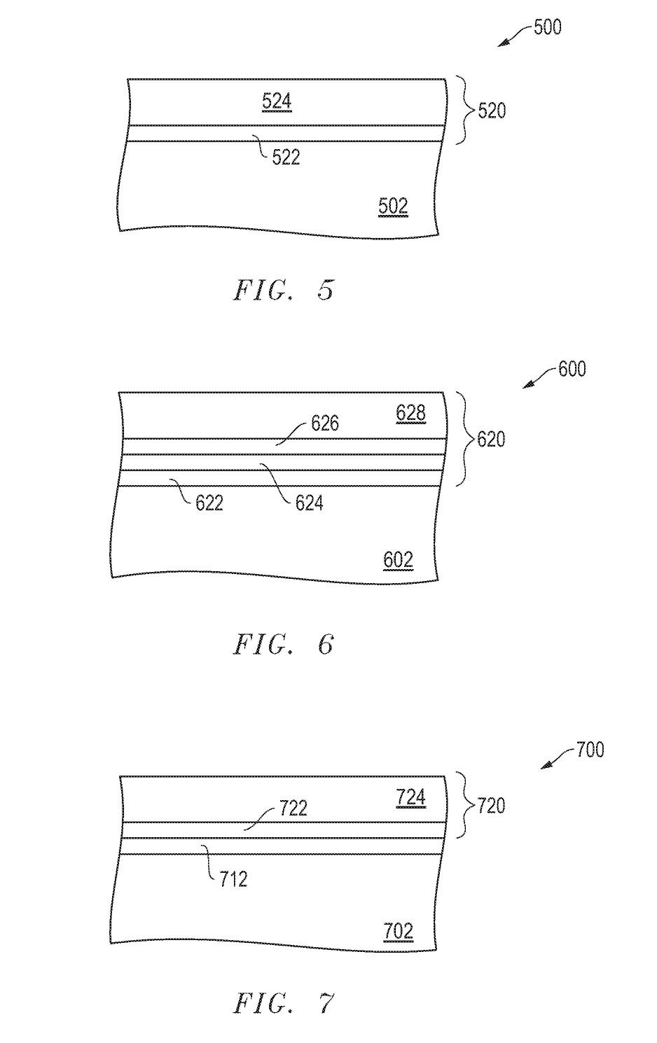

An adhesion layer may be used between the substrate and the corrosion-resistant layer if needed or desired. The embodiment as illustrated in FIG. 7 illustrates a component 700 that includes a substrate 702, a corrosion-resistant layer 720, and an adhesion layer 712 disposed between the substrate 702 and the corrosion-resistant layer 720. The substrate 702 can include any of the materials as previously described with respect to the substrate 502. In this embodiment, the corrosion resistant layer 720 includes any of the compositions, thicknesses, porosities, or configurations as described with respect to either or both of the corrosion-resistant layers 520 and 620.

In one embodiment, the adhesion layer 712 includes molybdenum or tungsten. In another embodiment, the adhesion layer 712 includes silicon, germanium, SiC, or silicon-impregnated SiC. In a further embodiment, the adhesion layer 712 can include plasma-sprayed alumina or a coated-and-fired silica or a silicate material, for example, aluminum silicate. In still another embodiment, the adhesion layer 712 can consist essentially of an anodization layer formed from a metal; the anodization layer typically includes mostly amorphous alumina.

The adhesion layer 712 can have a thickness sufficient such that is it not eroded away during the formation of the corrosion-resistant layer 720. In a particular embodiment, the thickness of the adhesion layer 712 can be at least approximately 10 nm. In another particular embodiment, the thickness can be at least approximately 30 nm. Although no theoretical upper limit is known for the adhesion layer 712, beyond a certain thickness, no significant further benefit is achieved, and therefore, additional resources are consumed needlessly in order to thicken the adhesion layer 712. In a particular embodiment, the adhesion layer 712 has a thickness no greater than approximately 1 mm.

According to another aspect of the present invention, the corrosion-resistant layer is formed adjacent to the underlying substrate by a thermal spraying process. U.S. Pat. No. 7,329,467 discloses particular embodiments that can be used in thermal spraying processes and is incorporated herein with respect to the thermal spraying processes. One or more process parameters can affect the porosity, and hence the density, of the portion of the corrosion-resistant layer being formed. Much of the particular details below are described with respect to the embodiment as illustrated in FIG. 5. After reading this specification, skilled artisans will appreciate that such details may be extended to cover other embodiments as described herein. Further, changes in process parameters below are described in terms of relative values because actual values may depend on the particular apparatus used to form the corrosion-resistant layer. In other words, the actual values of the parameters may be specific to the particular equipment used, and the actual values for one set of equipment may be different from another set of equipment.

In an embodiment, porosity of the corrosion-resistant layer can be changed by changing the spray distance, which is the distance between the surface of the component being sprayed and the tip of the spraying nozzle. The porosity of the corrosion-resistant layer can be increased by increasing the spray distance. Referring to the embodiment of FIG. 5, the spray distance when forming the portion 524 will be larger than the spray distance when forming the portion 522. In a particular embodiment, the spray distance when forming the portion 524 will be at least approximately 5% longer than the spray distance when forming the portion 522. In another particular embodiment, the spray distance when forming the portion 524 will be at least approximately 25% longer than the spray distance when forming the portion 522. In a further particular embodiment, the spray distance when forming the portion 524 will be no greater than approximately 95% longer than the spray distance when forming the portion 522. In a still further particular embodiment, the spray distance when forming the portion 524 will be no greater than approximately 500% longer than the spray distance when forming the portion 522.

For example, the spray distance when forming the portion 522 is in a range of approximately 80 to approximately 90 mm, and the spray distance when forming the portion 522 is in a range of approximately 105 to approximately 115 mm. In a particular example, the spray distance when forming the portion 522 is 85 mm, and the spray distance when forming the portion 522 is 110 mm

In another embodiment, porosity of the corrosion-resistant layer can be changed by changing the arc current of the plasma when thermal spraying is performed using a plasma. The porosity of the corrosion-resistant layer can be increased by decreasing the arc current. Referring to the embodiment of FIG. 5, the arc current when forming the portion 524 will be larger than the arc current when forming the portion 522. In a particular embodiment, the arc current when forming the portion 524 will be at least approximately 5% lower than the arc current when forming the portion 522. In another particular embodiment, the arc current when forming the portion 524 will be at least approximately 20% lower than the arc current when forming the portion 522. In a further particular embodiment, the arc current when forming the portion 522 will be no greater than approximately two times the arc current when forming the portion 524. In a still further particular embodiment, the arc current when forming the portion 522 will be no greater than approximately ten times the arc current when forming the portion 524.

In a further embodiment, porosity of the corrosion-resistant layer can be changed by changing the gas feed composition. The porosity of the corrosion-resistant layer can be increased by decreasing the gas flow rate of hydrogen, helium, nitrogen or some combination of these. Referring to the embodiment of FIG. 5, the concentration of hydrogen, helium, or both within the gas feed when forming the portion 524 will be less than the concentration of hydrogen, helium, or both within the gas feed when forming the portion 522. In a particular embodiment, the concentration of hydrogen, helium, or both within the gas feed when forming the portion 524 will be at least approximately 4% lower than the concentration of hydrogen, helium, or both within the gas feed when forming the portion 522. In another particular embodiment, the concentration of hydrogen, helium, or both within the gas feed when forming the portion 524 will be at least approximately 20% lower than the concentration of hydrogen, helium, or both within the gas feed when forming the portion 522. In a further particular embodiment, the concentration of hydrogen, helium, or both within the gas feed when forming the portion 524 will be no greater than approximately 70% lower than the concentration of hydrogen, helium, or both within the gas feed when forming the portion 522. In a still further particular embodiment, the concentration of hydrogen, helium, or both within the gas feed when forming the portion 524 will be no greater than approximately 90% lower than the concentration of hydrogen, helium, or both within the gas feed when forming the portion 522. In a further embodiment, the gas flow rate of argon may be increased when the gas flow rate of helium is decreased, so that the total gas flow rate when forming the portion 524 is closer to the total gas flow rate when forming the portion 522, as compared to if the argon gas flow rate would not be increased when the helium gas flow rate is decreased.

In another embodiment, porosity of the corrosion-resistant layer can be changed by changing the particle size distribution in the feed stream. The porosity of the corrosion-resistant layer can be increased by increasing the averaged size of particles within the feed stream. Referring to the embodiment of FIG. 5, the averaged size of particles within the feed stream when forming the portion 524 will be larger than the averaged size of particles within the feed stream when forming the portion 522

In another embodiment, porosity of the corrosion-resistant layer can be changed by using different formation techniques. Referring to the embodiment of FIG. 5, the portion 522 can be formed by thermally spraying using a high velocity oxy-fuel technique, and the portion 524 can be formed by thermally spraying using a plasma torch. In a further embodiment, other combinations of formation techniques that produce different porosities deposited films can be used.

While much of the foregoing has focused on varying configurations of members or other components at least partially defining a processing apparatus for microelectronic processing, the above-described substrate/corrosion-resistant layer structure may be incorporated for generalized structures for various applications. In this regard, the substrate on which the corrosion-resistant layer is deposited may take on various geometric configurations for various corrosion-resistant applications.

The thermally sprayed corrosion-resistant layer as described herein demonstrates good adhesion strength, having an adhesion of not less than about 15 MPa, typically greater than 20 MPa and in certain embodiments not less than about 25 MPa, and not less than about 30 MPa. In a particular embodiment, the adhesion strength may be in a range of approximately 37 MPa to approximately 75 MPa.

After reading the specification, skilled artisans will appreciate that the concepts as described herein can be extended to different articles and are not limited to microelectronic processing components. More particularly, the other articles may be used in other apparatuses. For example, the methods described herein can be used to form corrosion-resistant layers as part of turbine blades for turbine engines, to protect layers within a fuel cell structure, or the like.

Some embodiments as described herein can take advantage of improved corrosion resistance of the corrosion-resistant layer by using a less porous portion adjacent to the substrate. Still other embodiments as described herein can take advantage of lower manufacturing costs of the corrosion-resistant layer by using a more porous portion farther from the substrate. The more porous portion can still have acceptable resistance to erosion due to physical abrasion or other physical phenomenon, even though the more porous portion by itself (i.e., in the absence of the less porous portion) may have unacceptably low corrosion resistance.

In yet another embodiment, combinations of good adhesion strength, corrosion resistance, erosion resistance, and lower manufacturing costs can be achieved by using a synergistic combination of the less porous and more porous portions of the corrosion resistant layer. Good adhesion strength may be achieved by the thermal spraying techniques described above. Because the substrate could be attacked by a corrosive material, the denser portion of the corrosion-resistant layer can be disposed closer to the substrate. Both the more porous and less porous portions are good are resisting erosion due to physical bombardment or other physical phenomenon. Still, a less porous portion, which is less expensive to manufacture can be formed such that it is disposed farther from the substrate, and in a more particular embodiment, along an exposed surface within the processing apparatus. Contrary to the synergy achieved in particular embodiments, the prior art has generally relied upon the use of a corrosion-resistant layer having a substantially uniform porosity throughout its thickness. If only a uniform relatively low porosity corrosion-resistant layer is used, adhesion strength is compromised as the layer is made thicker, which increases the likelihood of spalling. If good adhesion strength is achieved with the relatively low porosity corrosion-resistant layer, its thickness may be too thin and not provide sufficient resistance to erosion. If only a uniform relatively high porosity corrosion-resistant layer is used, corrosion resistance may be unacceptably low. Corrosive materials may migrate though a network of interconnected pores and reach the substrate. Hence, embodiments of corrosion-resistant layers having the synergistic combination of less porous and more porous portions can be used to achieve the benefits of a uniform relatively low porosity corrosion-resistant layer and a uniform relatively high porosity corrosion-resistant layer while substantially reducing the likelihood that adverse effects if the uniform relatively low porosity corrosion-resistant layer or the uniform relatively high porosity corrosion-resistant layer would be used.

Many different aspects and embodiments are possible. Some of those aspects and embodiments are described below. After reading this specification, skilled artisans will appreciate that those aspects and embodiments are only illustrative and do not limit the scope of the present invention.

In a first aspect, a microelectronic processing component can include a substrate including a metal-containing material, and a corrosion-resistant layer adjacent to the metal-containing material. The corrosion-resistant layer can includes a first portion and a second portion each including a rare earth compound, wherein the first portion is disposed between the substrate and the second portion, and the first portion has a first porosity, and the second portion has a second porosity that is greater than the first porosity.

In an embodiment of the first aspect, the component includes a component of a microelectronic processing apparatus. In a particular embodiment, the component is a chamber wall or a chamber lid. In another embodiment, the metal-containing material is an aluminum-containing material. In still another embodiment, the substrate has a surface region consisting essentially of alumina, stainless steel, or aluminum nitride. In yet another embodiment, the corrosion-resistant layer directly contacts the substrate.

In a further embodiment of the first aspect, the component further includes an adhesion layer disposed between the substrate and the corrosion-resistant layer. In a particular embodiment, the adhesion layer includes silica, a silicate, a thermally sprayed alumina, or any combination thereof. In still a further embodiment, the rare earth compound includes Y, La, Ce, or any combination thereof. In yet a further embodiment, the rare earth compound includes a rare earth oxide, a rare earth fluoride, or any combination thereof. In particular embodiment, the rare earth oxide consists essentially of Y₂O₃. In another particular embodiment, the rare earth oxide includes CeO₂, a yttrium aluminate, a yttrium silicate, a lanthanum aluminate, or a lanthanum silicate. In a further particular embodiment, the rare earth fluoride includes YF₃, CeF₃, CeF₄, or any combination thereof.

In another embodiment of the first aspect, the first portion of the corrosion-resistant layer includes a discrete film having a porosity no greater than approximately 5%. In still another embodiment, the corrosion-resistant layer has a porosity that changes as a continuous function of as a distance from the substrate, the first portion includes a particular portion closest to the substrate that includes 10% of a total thickness of the corrosion-resistant layer, and the first portion has an averaged porosity no greater than approximately 5%. In yet another embodiment, the first portion of the corrosion-resistant layer has a porosity no greater than approximately 3.5%. In a further embodiment, the first portion of the corrosion-resistant layer has a porosity no greater than approximately 3%. In still a further embodiment, the second portion of the corrosion-resistant layer includes a discrete film having a porosity of at least approximately 5%. In still another embodiment, the corrosion-resistant layer has a porosity that changes as a continuous function of a distance from the substrate, the second portion includes a particular portion farthest from the substrate includes 10% of a total thickness of the corrosion-resistant layer, and the second portion has an averaged porosity of at least approximately 5%.

In another embodiment of the first aspect, the second portion of the corrosion-resistant layer has a porosity no greater than approximately 25%. In still another embodiment, wherein the second portion of the corrosion-resistant layer has a porosity no greater than approximately 15%. In yet another embodiment, the component further includes a third portion and a fourth portion. The third portion is disposed between the first and second portions, the fourth portion is disposed between the third and second portions, the third portion has a porosity higher than the first and fourth portions, and the fourth portion has a porosity lower than the second and third portions. In a particular embodiment, the fourth portion is thinner than the second portion. In a further embodiment, the substrate includes a surface region consisting essentially of α-alumina or anodized aluminum. The first portion includes Y₂O₃ and has a thickness in a range of approximately 15 microns to approximately 450 microns, and the first porosity is no greater than approximately 3.5%. The second portion consists essentially of Y₂O₃ and has a thickness in a range of approximately 25 microns to approximately 800 microns, and the second porosity is in a range of approximately 5% to approximately 10%.

In a second aspect, a method of forming an article can include providing a substrate including a metal-containing material, thermally spraying a first portion of a corrosion-resistant layer on the substrate, wherein during a first time period, the thermal spraying is performed using a set of thermal spraying parameters. The method can further include changing a particular parameter within the set of thermal spraying parameters, and after changing the particular parameter, thermally spraying a second portion of the corrosion-resistant layer, wherein the second portion is more porous than the first portion.

In an embodiment of the second aspect, the particular parameter includes a spray distance, an arc current, a feed gas composition, a particle size distribution of a feed material, or any combination thereof. In another embodiment, the first portion and the second portion have substantially a same composition. In a further embodiment, the substrate includes a surface region consisting essentially of α-alumina or anodized aluminum, and the corrosion-resistant layer consists essentially of Y₂O₃.

In a third aspect, a microelectronic workpiece processing apparatus can include a chamber at least partially defined by a chamber wall, the chamber wall having a surface region including a metal-containing material, and a corrosion-resistant layer lining the chamber wall and adjacent to the metal-containing material. The corrosion-resistant layer can include a first portion and a second portion each including a rare earth compound, the first portion can be disposed between the substrate and the second portion, and the first portion can have a first porosity, and the second portion can have a second porosity that is greater than the first porosity. The apparatus can further include a support for supporting a microelectronic workpiece in the chamber.

In an embodiment of the third aspect, the apparatus further includes a gas inlet for passing at least one gas into the chamber. In another embodiment, the apparatus further includes an electromagnetic field generator for generating an electromagnetic field for passage through the chamber wall. In still another embodiment, the chamber wall includes a lid. In a further embodiment, the support includes an electrostatic chuck. In a further embodiment, the processing apparatus is an etching tool.

In another embodiment of the third aspect, the metal-containing material includes alumina, silica, silicon carbide, or aluminum nitride. In yet a further embodiment, the metal-containing material consists essentially of alumina. In still another embodiment, the corrosion-resistant layer includes Y, Ce, La, or any combination thereof. In yet another embodiment, the corrosion-resistant layer consists essentially of Y₂O₃. In a further embodiment, the corrosion-resistant layer includes YF₃, CeF₃, CeF₄, or any combination thereof. In still a further embodiment, the corrosion-resistant layer is thermally sprayed layer on the metal-containing material.

In a fourth aspect, a method of processing microelectronic workpieces can include placing a microelectronic workpiece into a processing apparatus, the apparatus including a support for receiving the microelectronic workpiece and a chamber in which the support is provided, the chamber being at least partially defined by a chamber wall including a metal-containing material, a corrosion-resistant layer being disposed between the metal-containing material and the chamber. The corrosion-resistant layer can include a first portion and a second portion each including a rare earth compound, the first portion can be disposed between the substrate and the second portion, and the first portion can have a first porosity, and the second portion can have a second porosity that is greater than the first porosity. The method can further include subjecting the microelectronic workpiece to a processing operation, including introducing at least one processing gas into the chamber, the processing gas being introduced to react with the microelectronic workpiece.

In an embodiment of the fourth aspect, the method further includes subjecting the microelectronic workpiece to an electromagnetic field. In another embodiment, the processing gas includes a halogen component. In still another embodiment, the processing gas removes material from the microelectronic workpiece. In a further embodiment, the method further includes dicing the microelectronic die into individual die including a semiconductor device. In a particular embodiment, the method further includes packaging the individual die. In still a further embodiment, the workpiece includes a display matrix having display elements.

Note that not all of the activities described above in the general description or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

1. A microelectronic processing component comprising:
a substrate including a metal-containing material; and
a corrosion-resistant layer adjacent to the metal-containing material, wherein:
the corrosion-resistant layer includes a first portion and a second portion each including a rare earth compound;
the first portion is disposed between the substrate and the second portion; and
the first portion has a first porosity, and the second portion has a second porosity that is greater than the first porosity.

2. The component of claim 1, wherein the component is part of a microelectronic processing apparatus.

3-4. (canceled)

5. The component of claim 1, wherein the metal-containing material is an aluminum-containing material.

6. The component of claim 1, wherein the substrate has a surface region consisting essentially of alumina, stainless steel, silicon carbide, or aluminum nitride.

7. The component of claim 1, wherein the corrosion-resistant layer directly contacts the substrate.

8. The component of claim 1, further comprising an adhesion layer disposed between the substrate and the corrosion-resistant layer.

9-10. (canceled)

11. The component of claim 1, wherein the rare earth compound comprises a rare earth oxide, a rare earth fluoride, or any combination thereof.

12-14. (canceled)

15. The component of claim 1, wherein the first portion of the corrosion-resistant layer includes a discrete film having a porosity no greater than approximately 5%.

16-18. (canceled)

19. The component of claim 1, wherein the second portion of the corrosion-resistant layer includes a discrete film having a porosity of at least approximately 5%.

20. The component of claim 1, wherein:
the corrosion-resistant layer has a porosity that changes as a continuous function of a distance from the substrate;
the second portion comprises a particular portion farthest from the substrate includes 10% of a total thickness of the corrosion-resistant layer; and
the second portion has an averaged porosity of at least approximately 5%.

21. The component of claim 1, wherein the second portion of the corrosion-resistant layer has a porosity no greater than approximately 25%.

22-24. (canceled)

25. The component of claim 1, wherein:
the substrate includes a surface region consisting essentially of α-alumina or anodized aluminum;
the first portion comprises Y₂O₃ and has a thickness in a range of approximately 15 microns to approximately 450 microns;
the first porosity is no greater than approximately 3.5%;
the second portion consists essentially of Y₂O₃ and has a thickness in a range of approximately 25 microns to approximately 800 microns; and
the second porosity is in a range of approximately 5% to approximately 10%.

26. A method of forming an article comprising:
providing a substrate including a metal-containing material;
thermally spraying a first portion of a corrosion-resistant layer on the substrate, wherein during a first time period, the thermal spraying is performed using a set of thermal spraying parameters;
changing a particular parameter within the set of thermal spraying parameters; and
after changing the particular parameter, thermally spraying a second portion of the corrosion-resistant layer, wherein the second portion is more porous than the first portion.

27. The method of claim 26, wherein the particular parameter includes a spray distance.

28. The method of claim 26, wherein the particular parameter includes an arc current.

29-30. (canceled)

31. The method of claim 26, wherein the first portion and the second portion have substantially a same composition.

32. (canceled)

33. A microelectronic workpiece processing apparatus comprising:
a chamber at least partially defined by a chamber wall, the chamber wall having a surface region including a metal-containing material;
a corrosion-resistant layer lining the chamber wall and adjacent to the metal-containing material, wherein:
the corrosion-resistant layer includes a first portion and a second portion each including a rare earth compound;
the first portion is disposed between the substrate and the second portion; and
the first portion has a first porosity, and the second portion has a second porosity that is greater than the first porosity; and
a support for supporting a microelectronic workpiece in the chamber.

34-37. (canceled)

38. The apparatus of claim 33, wherein the processing apparatus is an etching tool.

39. The apparatus of claim 33, wherein the metal-containing material comprises alumina, silica, silicon carbide, or aluminum nitride.

40. (canceled)

41. The apparatus of claim 33, wherein the corrosion-resistant layer includes Y, Ce, La, or any combination thereof.

42-64. (canceled)
